(19) United States
(12) Patent Application Publication
(10) Pub. No.: US 2026/0134777 A1
(43) Pub. Date: May 14, 2026

(54) ATTENTION ATTRACTING DEVICE AND ATTENTION ATTRACTING METHOD

(71) Applicant: HONDA MOTOR CO., LTD., Tokyo (JP)

(72) Inventors: Haruko Okuyama, Wako-shi (JP); Tatsuya Iwasa, Wako-shi (JP); Tsuyoshi Nojiri, Wako-shi (JP); Toshihiro Hashimoto, Wako-shi (JP); Yuichiro Shimura, Wako-shi (JP)

(21) Appl. No.: 19/361,593

(22) Filed: Oct. 17, 2025

(30) Foreign Application Priority Data
Nov. 11, 2024 (JP) 2024-196731

(51) Int. Cl. G08G 1/16; G06V 20/58; G10L 13/02

(52) U.S. Cl. CPC G08G 1/16; G06V 20/58; G10L 13/02; G06V 2201/08

(57) ABSTRACT

An attention attracting device includes: a risk index value acquisition unit acquiring, based on outputs of a plurality of sensors mounted on a vehicle, a risk index value indicating a collision risk between a target object present in front of the vehicle and the vehicle; and a notification control unit outputting a voice in a language to notify a driver of the vehicle of the target object when a target object with the risk index value equal to or greater than a first threshold value is detected, and being configured to notify the driver of a change in the risk index value using a method other than a notification by the voice in the language when the risk index value changes by a value equal to or greater than a second threshold value while notifying the driver of the target object by outputting the voice in the language.

### INCORPORATION BY REFERENCE

The present application claims priority under 35 U.S.C. § 119 to Japanese Patent Application No. 2024-196731 filed on Nov. 11, 2024. The content of the application is incorporated herein by reference in its entirety.

### BACKGROUND OF THE INVENTION

### Field of the Invention

The present invention relates to an attention attracting device and an attention attracting method.

### Description of the Related Art

In recent years, systems have been known in which a plurality of human machine interface (HMI) devices notify a driver of a vehicle of risks.

For example, a driving support device disclosed in Japanese Patent Laid-Open No. 2002-342899 obtains object information including a position, a traveling direction, and a vehicle speed of other vehicles, detects traveling information including a position, a traveling direction, and a vehicle speed of an own vehicle, and includes a notification means for issuing a notification based on the detected information. In addition, the driving support device includes, as the notification means, a display device for displaying a positional relationship between the own vehicle and the other vehicles on a map and a speaker that outputs a voice according to a risk level.

Furthermore, an information providing device disclosed in Japanese Patent Laid-Open No. 2005-352645 includes an output control means for outputting voice output information by a voice and displaying display output information generated based on at least a part of the voice output information immediately before the voice output information is output. The display output information is displayed and output for a predetermined time immediately before the voice output information corresponding to the display output information is output by the voice.

However, since multiple voices are output in a short period of time when a plurality of pieces of information are notified to a driver, who is driving, only by a voice, there is a problem to be improved in terms of ease of intuitive understanding. The present application aims to improve visibility in order to solve the above problem. In addition, the present application aims to further improve traffic safety and contribute to development of a sustainable transportation system.

### SUMMARY OF THE INVENTION

An aspect of the present invention provides an attention attracting device including: an index value acquisition unit that acquires, based on outputs of a plurality of sensors mounted on a vehicle, a risk index value indicating a collision risk between a target object present in front of the vehicle and the vehicle; and a notification control unit that outputs a voice in a language to notify a driver of the vehicle of the target object when a target object with the risk index value equal to or greater than a first threshold value set in advance is detected, the notification control unit being configured to notify the driver of the vehicle of a change in the risk index value using a method other than a notification by the voice in the language when the risk index value changes by a value equal to or greater than a second threshold value set in advance while notifying the driver of the vehicle of the target object by outputting the voice in the language.

In another aspect of the present invention, the notification control unit is configured to, when the risk index value falls below the first threshold value, finish the notification by the voice in the language and notify the driver of the vehicle of the change in the risk index value using a method other than the notification by the voice in the language.

In another aspect of the present invention, the notification control unit is configured to notify the driver of the vehicle of the change in the risk index value through a display by a visual HMI device or a vibration by a tactile HMI device.

Another aspect of the present invention provides an attention attracting method of causing a processor of an attention attracting device mounted on a vehicle to execute: a step of acquiring, based on outputs of a plurality of sensors mounted on a vehicle, a risk index value indicating a collision risk between a target object present in front of the vehicle and the vehicle; a step of outputting a voice in a language to notify a driver of the vehicle of the target object when a target object with the risk index value equal to or greater than a first threshold value set in advance is detected; a step of notifying the driver of the vehicle of a change in the risk index value using a method other than a notification by the voice in the language when the risk index value changes by a value equal to or greater than a second threshold value set in advance while notifying the driver of the vehicle of the target object by outputting the voice in the language.

According to an aspect of the present invention, in a situation where voices in multiple languages are output in a short period of time, the driver of the vehicle can intuitively recognize that the level of risk has changed.

### BRIEF DESCRIPTION OF THE DRAWINGS

FIG. 1 is a diagram illustrating a configuration of a vehicle;

FIG. 2 is a diagram illustrating an example of a lighting display or blinking display; and

FIG. 3 is a flowchart illustrating an operation of an attention attracting device.

### DETAILED DESCRIPTION OF THE INVENTION

### [1. Configuration of Vehicle]

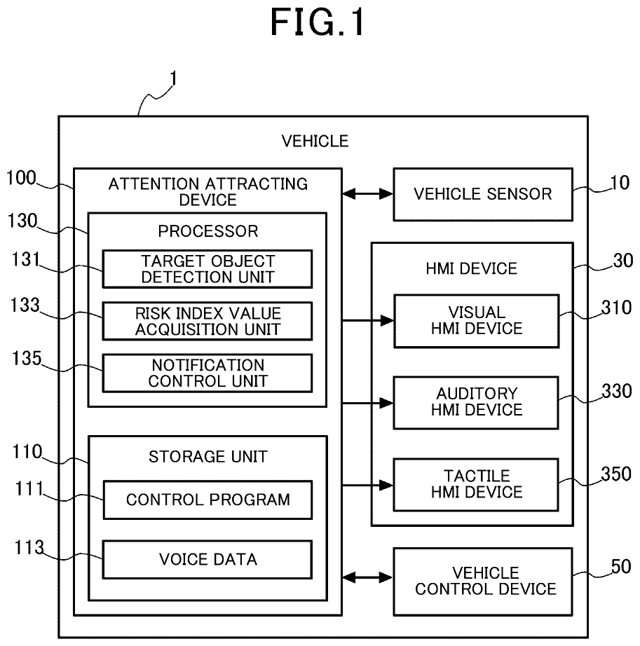

FIG. 1 is a diagram illustrating a configuration of a vehicle 1.

The vehicle 1 is mounted with a vehicle sensor 10, an HMI device 30, a vehicle control device 50 (computer), and an attention attracting device 100.

The vehicle sensor 10 includes at least one of one or more cameras, radar, lidar, and sonar distributed to a body of the vehicle 1, and detects target objects present around the vehicle 1. The vehicle sensor 10 outputs data measured by the cameras, radar, lidar, or sonar to the attention attracting device 100, as sensor data.

The HMI device 30 includes a visual HMI device 310 that outputs visual information, an auditory HMI device 330 that outputs sound as an auditory stimulus to a driver, and a tactile HMI device 350 that provides a stimulus to a driver's tactile sense.

The visual HMI device 310 is a head-up display provided on an instrument panel 4 of the vehicle 1. The head-up display notifies of the presence of a target object that may cause a collision by displaying an attention attracting display on the windshield 3 as a projection surface. A driver sitting in a driver's seat can see the attention attracting display along with a scene ahead of the vehicle 1 through the windshield 3.

The auditory HMI device 330 is a single speaker in the present embodiment. Alternatively, the auditory HMI device 330 may be a speaker system including a plurality of speakers.

The tactile HMI device 350 vibrates the driver's seat of the vehicle 1 to provide a tactile stimulus to the driver. The tactile HMI device 350 includes a vibration motor that generates vibrations in the seat in which the driver sits, and drives the vibration motor based on a vibration control signal input from the attention attracting device 100 to provide vibrations to the seat (not illustrated). The tactile HMI device 350 may be an electric seat belt that changes tension of the seat belt to provide a tactile stimulus to the driver.

The vehicle control device 50 detects manipulation states of driving operation instruments of the vehicle 1, for example, an acceleration pedal, a brake pedal, turn signal lights, and a steering wheel, and detects motion states of the vehicle 1, for example, a vehicle speed, acceleration, and a yaw rate.

### [2. Configuration of Attention Attracting Device]

The attention attracting device 100 is configured by an ECU or a computer including a storage unit 110, a processor 130, an input/output interface (not illustrated), and the like.

The storage unit 110 includes, for example, a non-volatile RAM (Read Only Memory), or ROM and RAM (Random Access Memory). Furthermore, the storage unit 110 may include an auxiliary storage device such as an SSD (Solid State Drive).

The storage unit 110 stores a control program 111 executed by the processor 130, voice data 113 of a language output from the auditory HMI device 330, and the like.

The processor 130 is an arithmetic processing device including a processor such as a CPU (Central Processing Unit) or an MPU (Micro-Processing Unit). The processor 130 may be configured with a single processor, or may be configured with a plurality of processors. In addition, the processor 130 may also be configured with an SoC integrated with part or all of the storage unit 110 or other circuits. The processor 130 may also be configured with a combination of a CPU that executes a program and a DSP (Digital Signal Processor) that executes predetermined arithmetic processing. Furthermore, the processor 130 may have a configuration in which all of functions are implemented in hardware or a configuration using a programmable device.

The attention attracting device 100 includes, as functional units, a target object detection unit 131, a risk index value acquisition unit 133, and a notification control unit 135. These functional units are implemented by the processor 130 that executes the control program 111 stored in the storage unit 110.

The target object detection unit 131 detects, based on the sensor data input from the vehicle sensor 10, target objects present around the vehicle 1. The target objects are objects that may collide with or come into contact with the vehicle 1, and need to be notified the driver of the vehicle 1 of the presence thereof. Examples of the target objects to be detected by the target object detection unit 131 include pedestrians, other vehicles, and stationary objects such as walls or utility poles. The target object detection unit 131 of the present embodiment detects, as a target object, an object that is present ahead of the vehicle 1 in a traveling direction and may come into contact with or collide with the vehicle 1. In other words, the target object detection unit 131 detects a target object present ahead of the vehicle 1 when the vehicle 1 travels forward, and detects a target object present behind the vehicle 1 when the vehicle 1 travels backward. The target object detection unit 131 detects a position, a moving speed, and a moving direction of the detected target object. The target object detection unit 131 outputs information indicating the position, the moving speed, and the moving direction of the detected target object to the risk index value acquisition unit 133.

The target object detection unit 131 may detect a target object or a relative position of the target object using a vehicle-to-vehicle communication device, a GNSS (Global Navigation Satellite Systems) unit, or a V2X (Vehicle-to-Everything) communication device or the like in addition to the sensor such as a front camera provided in the vehicle sensor 10. The target object detection unit 131 may also detect a target object appearing in a captured image or a relative position of the target object, using a determination in a virtual environment via a server. Communication partner in the VX2 communication includes other vehicles, pedestrians, networks, and infrastructures, for example.

The risk index value acquisition unit 133 receives, as an input, the information indicating the position, the moving speed, and the moving direction of the target object detected by the target object detection unit 131. In addition, the risk index value acquisition unit 133 receives, as an input, sensor data such as an image captured by the camera. The risk index value acquisition unit 133 corresponds to an index value acquisition unit.

For example, the risk index value acquisition unit 133 predicts a moving line between the target object and the vehicle 1, based on the position, the moving direction, and the moving speed of the target object, the position, the moving direction, and the moving speed of the vehicle 1, a lighting state of traffic lights detected from the image captured by the camera, and the like. The risk index value acquisition unit 133 calculates a risk index value based on a position where the vehicle 1 and the target object are closest to each other, and a distance between the vehicle 1 and the target object at the position. The risk index value is a value indicating the possibility of contact or collision between the vehicle 1 and the target object. The risk index value is obtained by, for example, scoring the position, the moving direction, and the moving speed of the target object, and the distance between the vehicle 1 and the target object, and then multiplying the scored values by a weighting coefficient to calculate the sum of the resulting values.

During a prediction of a moving line of the target object, when the target object is a vehicle, the risk index value acquisition unit 133 may take into consideration lighting states of turn signal lights and a brake light of the vehicle, and when the target object is a pedestrian, the risk index value acquisition unit 133 may take into consideration an orientation of a face of the pedestrian. Similarly, during a prediction of a moving line of the vehicle 1, the risk index value acquisition unit 133 may take into consideration lighting states of turn signal lights and a brake light of the vehicle 1 obtained from the vehicle sensor 10, and may take into consideration the route being guided if a navigation device (not illustrated) is guiding the route.

In addition, the risk index value acquisition unit 133 detects a risk of contact between the vehicle 1 and a target object actually detected in an environment surrounding the vehicle 1, and may also infer and detect a risk of contact with a target object (such as a virtual vehicle or a pedestrian) that has not yet been detected, but can appear based on visibility, the number of accidents, and the like at an intersection or the like. The risk index value acquisition unit 133 outputs the acquired risk index value to the notification control unit 135.

When a target object with risk index value equal to or greater than a first threshold value set in advance is detected, the notification control unit 135 plays back the voice data 113 of the language and causes the auditory HMI device 330 to output the voice in the language. For example, the notification control unit 135 causes the auditory HMI device 330 to output a voice in a language such as “There is a wall ahead” or “There is a person behind the wall”. The notification control unit 135 causes the auditory HMI device 330 to continuously output the voice in the language when the risk index value is equal to or greater than the first threshold value set in advance. In other words, the voice in the language is output from the auditory HMI device at regular intervals.

Next, the notification control unit 135 monitors a change in the risk index value input from the risk index value acquisition unit 133, and determines whether the change in the risk index value is equal to or greater than a second threshold value set in advance. The second threshold value is smaller than the first threshold value.

When the change in the risk index value is equal to or greater than the second threshold value set in advance, the notification control unit 135 notifies the driver of the change in risk index value using a method other than the notification by the voice in the language.

For example, when the risk index value rises or falls by the value equal to or greater than the second threshold value, the notification control unit 135 notifies the driver of the change in the risk index value through the visual HMI device 310 or the tactile HMI device 350.

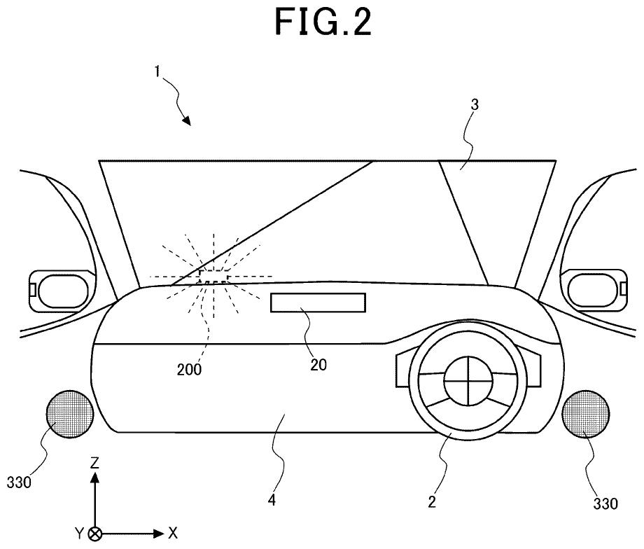

FIG. 2 is a diagram illustrating a lighting display or blinking display 200 displayed on the windshield 3 by the visual HMI device 310.

For example, when the notification control unit 135 notifies the driver of the change in the risk index value through the visual HMI device 310, the lighting display or blinking display 200 is displayed or a colored display is performed in a predetermined range near the instrument panel 4 on a passenger's seat side. Such a display is referred to as an attention attracting display. The predetermined range for displaying the attention attracting display is preferably within a range in which the field of view of the driver is not obstructed.

For example, whenever the risk index value rises by the value equal to or greater than the second threshold value, the notification control unit 135 increases luminance of the lighting display or the blinking display, speeds up a blinking interval, or changes the color of the colored display to a bright color or red.

In addition, whenever the risk index value falls by the value equal to or greater than the second threshold value, the notification control unit 135 reduces luminance of the lighting display or blinking display, slows the blinking interval, or changes the color of the colored display to a dark color or blue.

It is preferable that a timing of causing the visual HMI device 310 to display the attention attracting display or the tactile HMI device 350 to output vibrations does not overlap with a timing of causing the auditory HMI device 330 to output the voice in the language. This is because when two notifications overlap, it becomes difficult for the driver to recognize one of the outputs. For example, when a microphone is provided in the vehicle 1 and the voice in the language is input from the microphone, the timing of causing the visual HMI device 310 to display the attention attracting display or the tactile HMI device 350 to output vibrations may be delayed.

Moreover, the timing of causing the visual HMI device 310 to display the attention attracting display or the tactile HMI device 350 to output vibrations is more preferably before the auditory HMI device 330 outputs the voice in the language. When the voice in the language is output after the driver recognizes the change in the risk index value through the attention attracting display or the vibrations, the driver can easily recognize contents of the voice in the language.

Furthermore, the notification control unit 135 notifies the driver of the change in the risk index value through the tactile HMI device 350, thereby changing the vibration of the driver's seat.

For example, whenever the risk index value rises by the value equal to or greater than the second threshold value, the notification control unit 135 controls the tactile HMI device 350 to strengthen the vibration of the seat or shorten the interval between vibrations.

In addition, whenever the risk index value falls by the value equal to or greater than the second threshold value, the notification control unit 135 controls the tactile HMI device 350 to weaken the vibration level of the seat or lengthen the interval between vibrations.

When the risk index value falls below the first threshold value, the notification control unit 135 causes the auditory HMI device 330 to finish the notification by the voice in the language and notifies the driver of the vehicle that the risk index value falls, using a method other than the notification by the voice in the language. The notification control unit 135 notifies the driver of the change in the risk index value through the visual HMI device 310 or the tactile HMI device 350.

For example, when notifying the driver of the change in the risk index value through the tactile HMI device 350, the notification control unit 135 gradually reduces the luminance of the lighting display or blinking display and finally turns off the lighting display or blinking display. In addition, the notification control unit 135 changes the color of the colored display to a darker color and finally erases the colored display.

### [3. Operation of Attention Attracting Device]

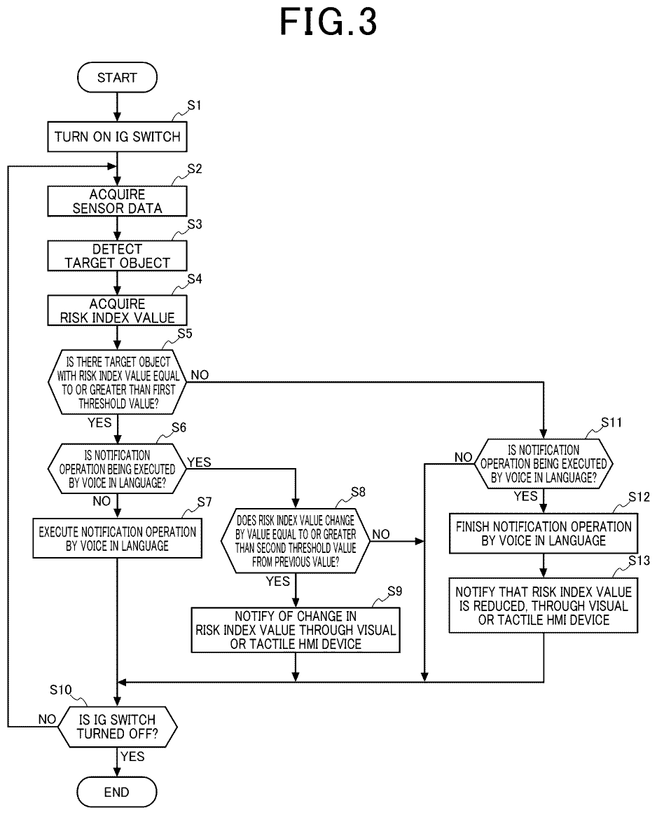

FIG. 3 is a flowchart illustrating an operation of the attention attracting device 100.

The operation of the attention attracting device 100 will be described with reference to the flowchart illustrated in FIG. 3.

First, when an IG switch of the vehicle is turned on (step S1), the attention attracting device 100 is started to acquire sensor data from the vehicle sensor 10 (step S2).

Next, the attention attracting device 100 detects a target object present around the vehicle 1 based on the sensor data (step S3), and detects a position, a moving speed, and a moving direction of the detected target object.

Next, the attention attracting device 100 acquires a risk index value of the detected target object (step S4). The attention attracting device 100, for example, scores the position, the traveling direction, and the moving speed of the target object, and the distance between the vehicle 1 and the target object, and multiplies the scored values by a weighting coefficient to calculate the sum of these values as the risk index value.

Next, the attention attracting device 100 determines whether there is a target object with the acquired risk index value equal to or greater than the first threshold value set in advance (step S5).

Where there is the target object with the risk index value equal to or greater than the first threshold value set in advance (YES in step S5), the attention attracting device 100 determines whether a notification operation is executed by a voice in a language (step S6).

When the notification operation is not executed by the voice in the language (NO in step S6), the attention attracting device 100 starts the notification operation by the voice in the language (step S7). The attention attracting device 100 plays back the voice data stored in the storage unit 110, and outputs the voice in the language through the auditory HMI device 330. Thereafter, the attention attracting device 100 determines whether an IG switch is turned off (step S10).

When it is determined that the notification operation is executed by the voice in the language (YES in step S6), the attention attracting device 100 compares a previous risk index value with a current risk index value for the same target object, and determines whether the risk index value changes by a value equal to or greater than the second threshold value (step S8).

When the attention attracting device 100 determines whether the risk index value does not change by the value equal to or greater than the second threshold value (NO in step S8), the process proceeds to the determination in step S10.

Furthermore, when the risk index value changes by the value equal to or greater than the second threshold value (YES in step S8), the attention attracting device 100 notifies the driver of the change in the risk index value through the visual HMI device 310 or the tactile HMI device 350 (step S9). For example, the lighting display or blinking display is displayed on the windshield 3 by the visual HMI device 310 or the colored display is performed. The tactile HMI device 350 may also vibrate the seat of the driver's seat. Then, it is determined whether the IG switch is turned off (step S10).

When it is determined that there is no target object with the risk index value equal to or greater than the first threshold value (NO in step S5), the attention attracting device 100 determines whether the notification operation is being executed by the voice in the language (step S11). In other words, the attention attracting device 100 determines that there is the target object with the risk index value equal to or greater than the first threshold value, but whether the risk index value of the target object falls below the first threshold value.

For example, the attention attracting device 100 may set a flag indicating the presence of the target object for which the notification operation is being executed by the voice in the language on, and determine based on the flag being on or off whether the notification operation is being executed by the voice in the language. Furthermore, the attention attracting device 100 changes the flag to off when it is determined in step S5 that there is no target object with the risk index value equal to or greater than the first threshold value.

When the notification operation is being executed by the voice in the language (YES in step S11), the attention attracting device 100 causes the auditory HMI device 330 to finish the notification by the voice in the language (step S12). Thereafter, the attention attracting device 100 notifies the driver that the risk index value is reduced, through the lighting display or blinking display by the visual HMI device 310 or the vibration by the tactile HMI device 350 (step S13).

When the process of step S7, S9, or S13 is finished, the attention attracting device 100 determines whether the IG switch is turned off (step S10). When the attention attracting device 100 determines that the IG switch is not turned off (NO in step S10), the process returns to the determination of step S2. When the attention attracting device 100 determines that the IG switch is turned off (YES in step S10), the processing flow is ended.

### 4. Other Embodiments

The above-embodiment is merely one aspect, and may be arbitrarily changed and applicable.

The case has been described in the above-described embodiment in which the visual HMI device 310 is a HUD, but the visual HMI device 310 may also be display means, for example, a light emitting diode (LED).

Moreover, respective components of the vehicle 1 illustrated in FIG. 1 are an example, and the specific implementation form is not particularly limited. In other words, it is not necessarily required to implement hardware corresponding to respective components, but it is of course possible to construct a configuration in which the functions of the respective components are implemented by executing a program by one processor. In addition, some of the functions implemented by software in the above-described embodiment may be implemented by hardware, or some of the functions implemented by hardware may be implemented by software.

Further, the step units of the operations illustrated in FIG. 3 are divided according to the main processing contents, and the present invention is not limited by the manner in which the processing units are divided or the names of the processing units. Depending on the processing contents, the process may be divided into more step units. Further, one step unit may be divided so as to include more processing. In addition, the order of the steps may be changed as appropriate within the scope of the present invention.

Furthermore, when the attention attracting method using of the above-described attention attracting device 100 is to be implemented using the processor 130, the program to be executed by the processor 130 can be configured with a mode of recording medium or a mode of transmission medium that transmits the program. In other words, the control program 111 can also be implemented in a state where the control program 111 is recorded on a portable information recording medium. Examples of the information recording medium may include a magnetic recording medium such as a hard disk, an optical recording medium such as a CD, and semiconductor memory devices such as a USB (Universal Serial Bus) memory and an SSD (Solid State Drive), but other recording media can also be used.

### Configuration Supported by Above-Described Embodiment

The above-described embodiment supports the following configurations.

### (Configuration 1)

An attention attracting device includes: an index value acquisition unit that acquires, based on outputs of a plurality of sensors mounted on a vehicle, a risk index value indicating a collision risk between a target object present in front of the vehicle and the vehicle; and a notification control unit that outputs a voice in a language to notify a driver of the vehicle of the target object when a target object with the risk index value equal to or greater than a first threshold value set in advance is detected, the notification control unit being configured to notify the driver of the vehicle of a change in the risk index value using a method other than a notification by the voice in the language when the risk index value changes by a value equal to or greater than a second threshold value set in advance while notifying the driver of the vehicle of the target object by outputting the voice in the language.

According to the attention attracting device of Configuration 1, when the target object with the acquired risk index value equal to or greater than the first threshold value is detected, it is possible to notify the driver of the vehicle of the presence of the target object through the voice in the language. In addition, when the risk index value changes by the value equal to or greater than the second threshold value, the driver of the vehicle is notified of the change in the risk index value by a method other than the notification by the voice in the language. Therefore, in a situation where voices in multiple languages are output in a short period of time, the driver of the vehicle can intuitively understand the change in the risk index value.

### (Configuration 2)

In the attention attracting device of Configuration 1, the notification control unit is configured to, when the risk index value falls below the first threshold value, finish the notification by the voice in the language and notify the driver of the vehicle of the change in the risk index value using a method other than the notification by the voice in the language.

According to the attention attracting device of Configuration 2, when the risk index value falls below the first threshold value, the notification by the voice in the language is finished, and the driver of the vehicle is notified of the change in the risk index value by a method other than the notification by the voice in the language. Therefore, the driver of the vehicle can intuitively recognize the change in the risk index value.

### (Configuration 3)

In the attention attracting device of Configuration 1 or 2, the notification control unit is configured to notify the driver of the vehicle of the change in the risk index value through a display by a visual HMI device or a vibration by a tactile HMI device.

According to the attention attracting device of Configuration 3, the change in the risk index value is notified by the display through the visual HMI device or the vibration through the tactile HMI device. Therefore, the driver of the vehicle can intuitively recognize the change in the risk index value.

### (Configuration 4)

An attention attracting method of causing a processor of an attention attracting device mounted on a vehicle to execute: a step of acquiring, based on outputs of a plurality of sensors mounted on a vehicle, a risk index value indicating a collision risk between a target object present in front of the vehicle and the vehicle; a step of outputting a voice in a language to notify a driver of the vehicle of the target object when a target object with the risk index value equal to or greater than a first threshold value set in advance is detected; a step of notifying the driver of the vehicle of a change in the risk index value using a method other than a notification by the voice in the language when the risk index value changes by a value equal to or greater than a second threshold value set in advance while notifying the driver of the vehicle of the target object by outputting the voice in the language.

According to the attention attracting method of Configuration 4, when the target object with the acquired risk index value equal to or greater than the first threshold value is detected, it is possible to notify the driver of the vehicle of the presence of the target object through the voice in the language. In addition, when the risk index value changes by the value equal to or greater than the second threshold value, the driver of the vehicle is notified of the change in the risk index value by a method other than the notification by the voice in the language. Therefore, in a situation where voices in multiple languages are output in a short period of time, the driver of the vehicle can intuitively understand the change in the risk index value.

### REFERENCE SIGNS LIST

1 vehicle
3 windshield
4 instrument panel
10 vehicle sensor
30 HMI device
40 vibration unit
50 vehicle control device
100 attention attracting device
110 storage unit
111 control program
130 processor
131 target object detection unit
133 risk index value acquisition unit
135 notification control unit
200 lighting display or blinking display
310 visual HMI device
330 auditory HMI device
350 tactile HMI device

1. An attention attracting device comprising:
an index value acquisition unit that acquires, based on outputs of a plurality of sensors mounted on a vehicle, a risk index value indicating a collision risk between a target object present in front of the vehicle and the vehicle; and
a notification control unit that outputs a voice in a language to notify a driver of the vehicle of the target object when a target object with the risk index value equal to or greater than a first threshold value set in advance is detected,
the notification control unit being configured to notify the driver of the vehicle of a change in the risk index value using a method other than a notification by the voice in the language when the risk index value changes by a value equal to or greater than a second threshold value set in advance while notifying the driver of the vehicle of the target object by outputting the voice in the language.

2. The attention attracting device according to claim 1, wherein
the notification control unit is configured to, when the risk index value falls below the first threshold value, finish the notification by the voice in the language and notify the driver of the vehicle of the change in the risk index value using a method other than the notification by the voice in the language.

3. The attention attracting device according to claim 1, wherein
the notification control unit is configured to notify the driver of the vehicle of the change in the risk index value through a display by a visual HMI device or a vibration by a tactile HMI device.

4. An attention attracting method of causing a processor of an attention attracting device mounted on a vehicle to execute:
a step of acquiring, based on outputs of a plurality of sensors mounted on a vehicle, a risk index value indicating a collision risk between a target object present in front of the vehicle and the vehicle;
a step of outputting a voice in a language to notify a driver of the vehicle of the target object when a target object with the risk index value equal to or greater than a first threshold value set in advance is detected;
a step of notifying the driver of the vehicle of a change in the risk index value using a method other than a notification by the voice in the language when the risk index value changes by a value equal to or greater than a second threshold value set in advance while notifying the driver of the vehicle of the target object by outputting the voice in the language.
